(19) United States
(12) Patent Application Publication
(10) Pub. No.: US 2009/0144621 A1
(43) Pub. Date: Jun. 4, 2009

(54) RECORDING, PLAYBACK, AND VISUAL REPRESENTATION OF MACROS

(75) Inventors: Daniel M. Sangster, Bellevue, WA (US); Devon L. Ellis, Lacey, WA (US); Niranjan Jayawardana, Redmond, WA (US); Joseph K. Ngari, Seattle, WA (US); Sarah J. Fuelling, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/949,789

(22) Filed: Dec. 4, 2007

(51) Int. Cl. G06F 3/00

(52) U.S. Cl. 715/704

(57) ABSTRACT

The recording, playing back, and visual representation of macros is disclosed. For example, one embodiment involves a computing device configured to receive a macro record command, receive one or more input commands to be grouped as the macro, display a representation of the one or more input commands, wherein the representation changes between a first representation mode and a second representation mode based upon the one or more input commands, and receive a macro stop record command.

### BACKGROUND

Macro recorders allow a user to record a sequence of user inputs for a computing device and assign the sequence of inputs to a single input key or button. This allows a user to play back the entire sequence of user inputs by pressing the assigned key or button. Macros find use in many different environments. For example, macros are often used in computer gaming environments to simplify play where a complex sequence of inputs used to perform action in the game is condensed into a macro executable by a single input.

Macro recorders generally utilize a graphical user interface that represents a sequence of commands entered by a user as a string of symbols and/or alphanumeric characters that represent the specific commands entered. Generally, the depression and release of a key are considered separate commands to a macro recorder. Therefore, existing macro software may graphically represent a key press and release by a key down event followed by a delay followed by a key up event (A↓ [symbol] 10,A↑). Where there are many commands in the macro, this may make the graphical representation verbose and hard to read. Moreover, recording a new macro during game play or the like may currently call for a user to temporarily exit the game and record the macro using the graphical user interface, thereby disrupting the game playing experience.

### SUMMARY

Accordingly, the recording, playback, and visual representation of macros are disclosed below in the Detailed Description. For example, one disclosed embodiment comprises a computing device configured to receive a macro record command, to receive one or more input commands to be grouped as a macro, to display a representation of the one or more input commands in a first representation mode, to change the representation to a second representation mode based upon the one or more input commands, and to receive a macro stop record command.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a macro-recording mouse according to one embodiment of the present disclosure.

FIG. 2 shows a process flow illustrating an embodiment of a method for recording, playing back, and visually representing macros.

FIG. 3 shows a process flow illustrating an embodiment of a method for recording a macro with a mouse.

FIG. 4 shows an example of an embodiment of a representation of a mouse sensitivity setting on a display on a mouse.

FIG. 5 shows an embodiment of a representation of a series of non-overlapping macro commands.

FIG. 6 shows an embodiment of a representation of a series of nested overlapping macro commands.

FIG. 7 shows an embodiment of a representation of a series of non-nested overlapping macro commands.

FIG. 8 shows a computing device according to one embodiment of the present disclosure.

### DETAILED DESCRIPTION

Various embodiments are disclosed herein that relate to the recording, visual representation, and playback of macros. For example, some disclosed embodiments relate to the representation of keystrokes and other inputs made during the recording of a macro. Other disclosed embodiments relate to the recording of a macro via a macro record control on a computer mouse. Yet other embodiments may combine either or both of these concepts with other features.

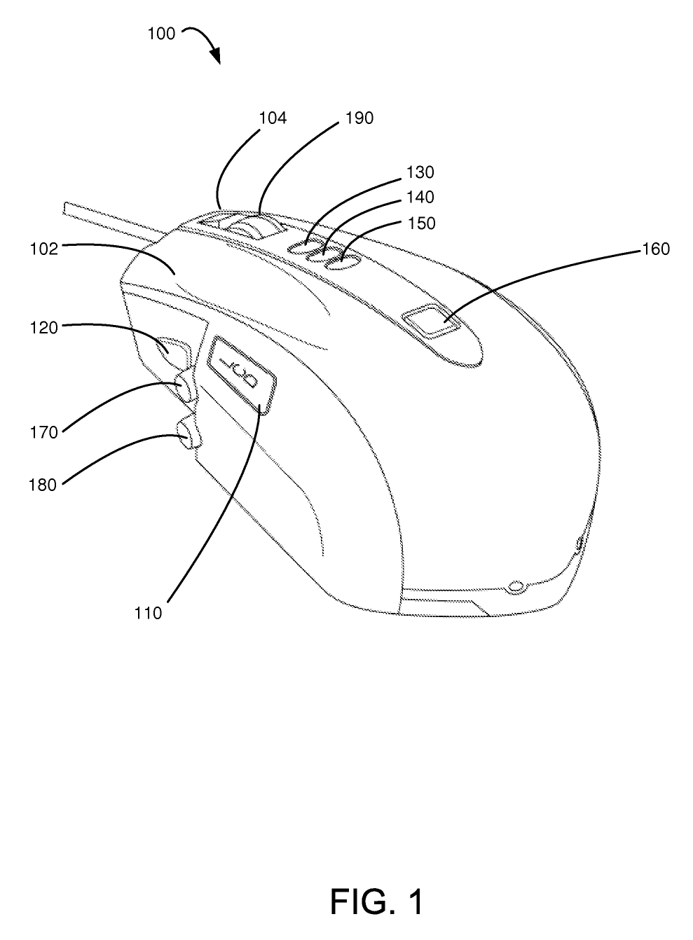

Turning now to the figures, FIG. 1 shows an embodiment of a mouse 100 according to the present disclosure. Mouse 100 includes various input controls, such as a left button 102, a right button 104, a scroll wheel 190, a macro record button 120, a first DPI selection button 130 (wherein DPI represents the sensitivity of the tracking sensor in the mouse in dots per inch), a second DPI selection button 140, a third DPI selection button 150, a first thumb button 170, a second thumb button 180, a special functionality button 160 (for example, a quick-launch button) and a liquid crystal display (LCD) 110. DPI selection buttons 130, 140 and 150 may also be referred to herein as mouse sensitivity buttons. While mouse 100 as shown is a wired mouse configured to be connected to a computing device with a cable, mouse 100 also may be configured to be connected to a computing device via a wireless connection. Further, while various embodiments below are disclosed with reference to mouse 100, it will be understood that mouse 100 is shown and described for the purpose of example, and the concepts disclosed herein may be implemented in any suitable mouse.

Macro record button 120 is configured to activate a macro recorder on a computing device to allow a user to control the recording of a macro via the mouse. This allows a user to record a macro, for example, while playing a video game in a full screen mode without switching to a macro recorder user interface. Likewise, in various embodiments, a user can record a macro from within a user interface window on a display without selecting the macro record button 120. Furthermore, the macro recorder may be configured to display instructions (alphanumeric, symbolic, etc.) on LCD 110 during a macro recording process to walk a user through the recording process. Further, in some embodiments in which LCD 110 has a sufficiently large size, the commands that are grouped as the macro may be displayed on LCD 110 during recording. Mouse 100 may be additionally configured to display a visual indicator during macro recording that alerts the user when the macro record button 120 is in a recording mode. Such an indicator may be displayed via LCD 110, via a light (such as an LED) that illuminates the macro record button 120, or in any other suitable manner.

Using mouse 100 as an input device, a user may create a timed macro comprising keyboard key presses, mouse clicks, and mouse sensitivity changes, and may assign the macro to a specific mouse input or mouse button. This allows the macro to be played back whenever the specific mouse input or mouse button is pressed. The macro may also be assigned to a keyboard button, or any other suitable input. Further, in some embodiments, the recorded macro may be recorded and stored in such a manner that it may be shared with other users. In addition to the ability to record macros during game play, a macro recorder according to the present disclosure also may be used to record macros in a standard macro record mode using a user interface on a computing device display.

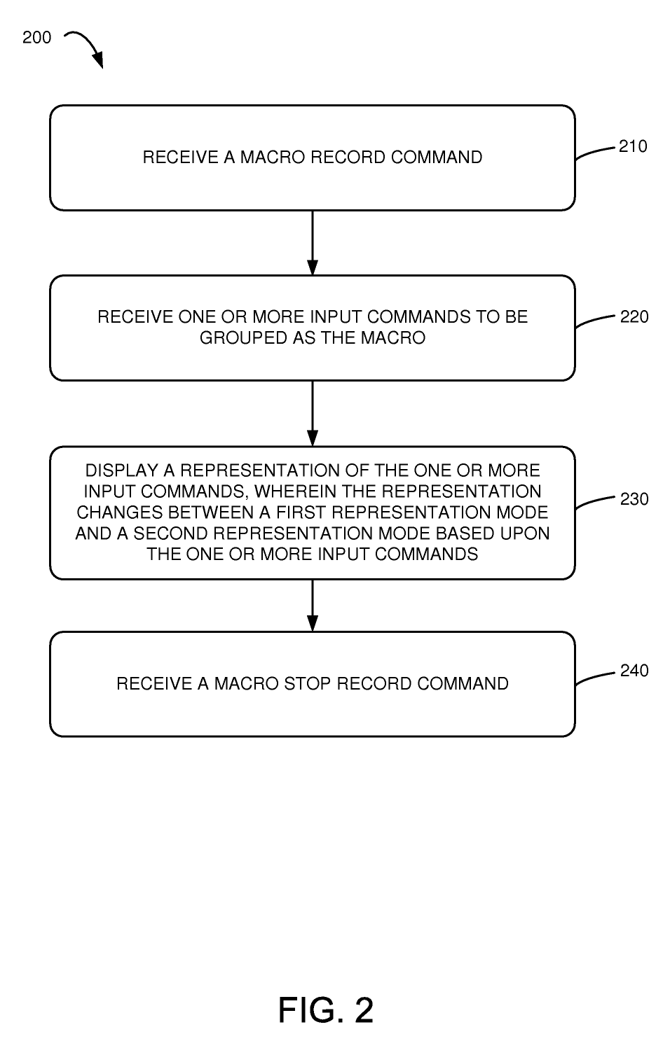

FIG. 2 shows a process flow illustrating an embodiment of a method 200 for recording, playing back, and visually representing macros for a mouse. Method 200 is shown from the standpoint of macro recording software executed on a computing device. As used herein, the term “computing device” may include any device that electronically executes one or more programs. The embodiments described herein may be implemented on one or more computing devices, for example, via computer-executable instructions or code, such as programs, stored on a computer-readable medium and/or in computing device memory and executed by a processor on the computing device. Generally, programs include routines, objects, components, data structures, and the like that perform particular tasks or implement particular abstract data types. The term “program”, “programming” and the like as used herein may connote a single program or multiple programs acting in concert, and may be used to denote applications, services, or any other type or class of program.

Continuing with FIG. 2, method 200 comprises, at 210, receiving a macro record command that commands the macro recorder to begin a recording process. Macro record commands may come from a keyboard, from a mouse button, from the selection of an icon on a graphical user interface on a computing device display (i.e. the selection of a “record” button on a macro recording graphical user interface window), or from any other suitable input device, as non-limiting examples. Next, as shown at 220, method 200 comprises receiving one or more input commands to be grouped as a macro, and displaying a representation of the one or more input commands at 230. Finally, method 200 comprises receiving a macro stop record command, as indicated at 240, which ends the macro recording process.

As indicated at 230, the representation of the one or more input commands on a user interface may change between a first representation mode and a second representation mode based upon a characteristic of the one or more input commands. For example, in some embodiments, the representation may change between a first representation mode and a second representation mode when multiple input commands overlap, whether partially or in a fully nested fashion. In this manner, a more compact representation mode may be used where there are no overlapping keystrokes, while a longer representation mode may be used to distinguish an order of overlapping commands where there are overlapping keystrokes. Examples of representation modes are described in more detail below.

The input commands that are grouped as the macro may include any suitable type of command. For example, the commands may include keyboard keystrokes, mouse movements, mouse button clicks, and/or changes in mouse movement sensitivity. Further, in some embodiments, the macro recorder may be configured to record mouse button inputs while excluding mouse position or movement input. This may allow a user to record a macro that includes mouse button inputs without having to hold the mouse still during the macro recording process.

It will be appreciated that other steps not shown in FIG. 2 may also be performed during a macro recording process. For example, the method may also include assigning the recorded macro to a specific input key or button that a user may select to perform the macro. Additionally, the macro recording method may further comprise sending various commands to mouse 100 to display via the LCD 110. For example, the method may comprise sending a command to the mouse to illuminate or blink a light on mouse 100 to indicate that the macro recorder is currently in macro record mode. In another example, the method may further comprise sending a command to mouse 100 to display a macro play mode indicator on LCD 110 indicating that a macro is currently being played. This may be helpful to alert a user that a macro is being played where the macro includes long pauses between commands. It will be appreciated that there examples are described for the purpose of illustration, and are not intended to be limiting in any manner.

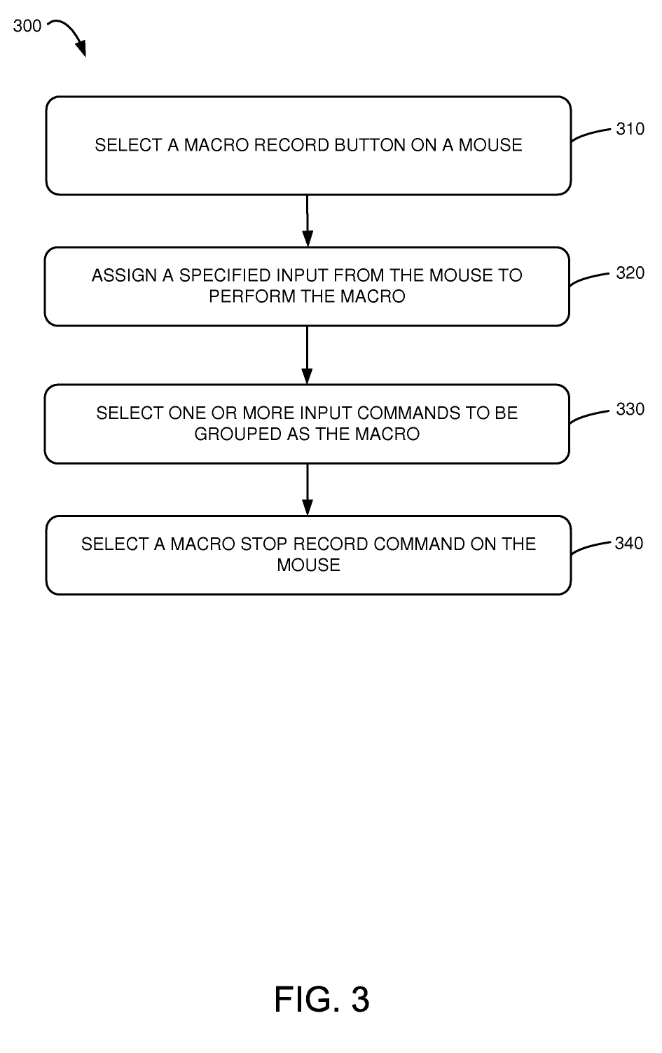

Continuing with the Figures, FIG. 3 shows a process flow illustrating an embodiment of a method 300 for recording, playing back, and visually representing macros for a mouse. Method 300 is described from the viewpoint of a user recording a macro via macro record button 120 on mouse 100. First, as shown in block 310, method 300 comprises selecting a macro record button on a mouse to initiate a macro record process. Next, as shown in block 320, a specified input on the mouse to which the macro is desired to be assigned is selected. The macro may be assigned to any suitable input, including but not limited to any suitable mouse button. Then, a user selects one or more input commands to be grouped as the macro, as shown in block 330. Finally, in block 340, the user selects a macro stop record command. After recording is complete, a user may select the specified input from the mouse to cause the macro to be performed. In some embodiments, the macro stop record command in block 340 is generated by the selection of the macro record button 120 during recording, while in other embodiments, another input may end a macro recording process.

In some embodiments, one or more instructions may be displayed to a user on LCD 110 instructing a user how to perform a macro recording process. For example, symbolic instructions may be displayed on LCD 110 instructing a user which operations to perform during each step of a macro recording process. In one specific example, after the macro record button 120 is pressed, a mouse icon may be displayed on LCD 110 instructing the user to provide a specified mouse button (or other input) to assign the macro. Upon selection of the input to which the macro is assigned, another symbol may be displayed instructing a user to enter one or more commands to be grouped as the macro, and/or instructing a user to again push the macro record button 120 to end a recording process. In this manner, a macro recording process may be performed without displaying a user interface on a computing device display. This may allow macro recording to be performed during play of a video game or the like.

As mentioned above, a user may desire to record and play changes in mouse movement sensitivity via a macro. As an example, a user of mouse 100 may use the macro recording feature referred to in FIG. 2 and FIG. 3 to record DPI setting changes with DPI selection buttons 130-150. For example, in a first game environment a user may desire a higher sensitivity setting for a first mouse movement sensitivity to enable large displayed movements with relatively small mouse movements, while in another game environment a user may desire a lower sensitivity setting to enable small displayed movements with relatively large mouse movements.

One common example of such usage environments is a first person shooter game that involves both character movements and high-precision inputs such as use of a scoped rifle. A user may record a DPI setting change using mouse 100 by selecting macro record button 120 and then one or more DPI setting changes. In this way, DPI setting changes can be combined with other keyboard or mouse inputs, thus allowing a user to enjoy complex gaming actions with fewer real-time inputs. As a specific example, when using standard (non-macro) game inputs, a user may depress a J key on a keyboard to switch a gaming character to a scoped rifle, and once the character has the scoped rifle the user may switch mouse sensitivity via the DPI selection buttons on the mouse to aim the scoped rifle accurately. To simplify this input sequence, the user may record a macro including commands to depress the J key and to adjust mouse sensitivity. Further, the macro can be assigned to a mouse button so the user may play the macro by selecting the mouse button. Other embodiments may assign one or multiple macros to any suitable combination of mouse button actions and mouse input commands.

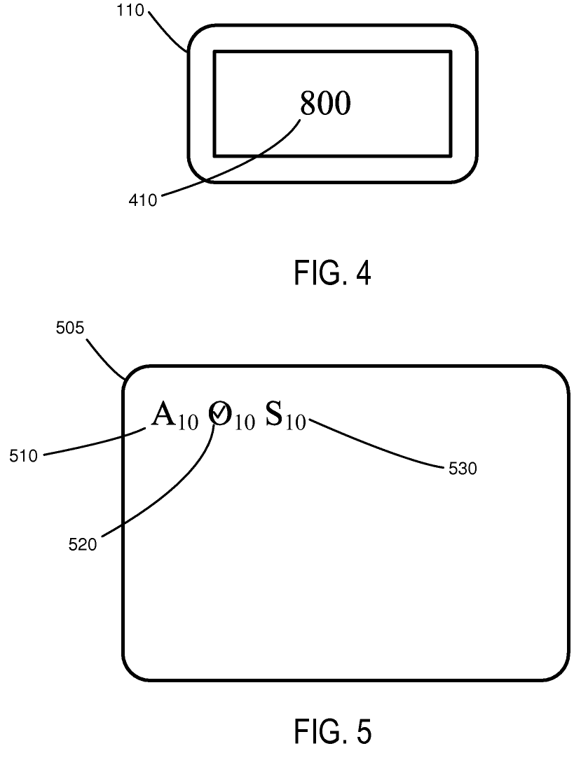

In some embodiments, the sensitivity setting of the mouse may be displayed on LCD 110 (or other mouse display). FIG. 4 shows an example of the display of a mouse sensitivity setting on LCD 110 with the number “800” displayed on the display. In this example, the number “800” represents the mouse sensitivity (in DPI) currently in use. Upon selection of a different DPI selection button, the number displayed on LCD 110 changes to the newly selected sensitivity. In one specific example, DPI selection button 130 may have a setting of 400 DPI, DPI selection button 140 may have a setting of 800 DPI, and DPI selection button 150 may have a DPI setting of 2000 DPI. Other embodiments may have different DPI settings. Via the DPI selection buttons and the display of the current DPI setting on LCD 110, a user can quickly determine and adjust mouse sensitivity settings. Further, a user can incorporate the correct setting into a macro for playback on mouse 100 as described herein.

FIGS. 5-7 show some examples of embodiments of visual representations of macro commands. As mentioned above, current graphical and textual representations of macro commands can be verbose and confusing. In some current macro recorders, even relatively simple input keystrokes may be visually represented via a user interface in an overly complex manner. For example, existing macro software may graphically represent a key press and release by symbols representing a key down event followed by a delay followed by a key up event, such as A↓ [symbol] 10 A↑ to designate pressing and holding the A key for 10 units of time (for example, milliseconds). This representation uses 6 characters to represent depressing one key for a specific time.

Representations of multiple keystrokes can be even more verbose. For example, a representation of two keys that are pressed in an overlapping manner may include a “+” in between representations of each key. For example, if a user depressed a shift key and an A key in an overlapping manner, a macro representation may show the following: a symbolic representation of (1) a shift key, followed by (2) a down arrow, followed by (3) a time symbol with a subscript showing how many milliseconds (or other suitable unit of time) the shift key is depressed before the A key, followed by (4) a symbolic representation of an A key, followed by (5) a down arrow, followed by (6) a time symbol with a subscript showing how many milliseconds the keys are held down simultaneously until one is released, followed by (7) a representation of an A key, followed by (8) an up arrow, followed by (9) a time symbol with a subscript showing how many second pass between the release of the A key and the next event, followed by (10) a representation of a shift key, followed by (11) an up arrow. As can be seen, the representation of such a macro can become lengthy and difficult to read where the macro has a large number of commands and/or overlapping commands.

In light of this, embodiments of macro recorders according to the present disclosure may provide for a more concise representation of macro commands. Further, some embodiments may switch between two or more different representation modes to provide efficient yet precise representations of command strings for specific use cases.

Referring to FIG. 5, a first representation mode is shown in which a key depress/release operation is represented in a more concise manner than described above for current macro recorders. For example, instead of using A↓, [symbol] 10, A↑ to designate pressing and holding the A key for 10 milliseconds, the embodiment of FIG. 5 represents this action with the display of A₁₀ as a designation. The press/release actions are represented simply by a representation of the pressed key itself, and the subscript gives the elapsed time between the press and release of the key. Where a macro comprises multiple key press/release operations, this notation may make the symbolic representation of the macro easy to read. For example, as shown in the figure, A₁₀ [symbol] S₁₀ can be used to represent the same macro commands as would otherwise be represented by A↓, [symbol] , A↑, [symbol] S↓, [symbol] , S↑.

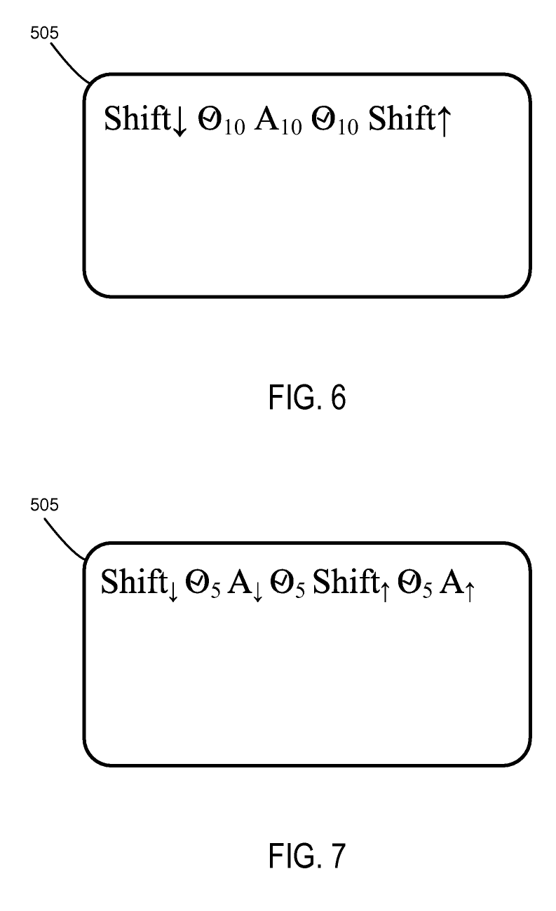

In some embodiments, a representation mode other than that shown in FIG. 5 may be used to represent overlapping keystrokes, whether partially overlapping or fully nested. FIGS. 6 and 7 illustrate variations of the representation of overlapping input commands and/or keystrokes. First, FIG. 6 illustrates the representation of a keystroke (A) that is fully nested within another keystroke (shift). In this representation, more specific keystrokes are used to represent the outer keystroke of the nested pair, while a simpler representation is used to represent the inner keystroke of the nested pair. Referring to the figure, the depression of the shift key is shown as a “shift key” representation, a down arrow, and a clock with subscript that represents the delay between the depression of the shift key and the A key. On the other hand, the depression and release of the A key is represented in the simpler representation described above with respect to FIG. 5. The release of the shift key is again shown by a time symbol that represents the time passage between the release of the A key, then a representation of the shift key and an up arrow indicating release of the shift key.

During macro recording, the macro command representation mode may change between the first and second display modes when a first input command becomes overlapping with a second input command. For example, if a shift key is pressed and held for 10 milliseconds before an A key is pressed, the shift key press and hold may be represented on the user interface initially in the first, shorter representation mode. Then, upon depression of the A key while the shift key is still being held, the shift key representation may change to the second, longer representation, while the A key may be shown in the first, shorter representation.

In other situations with overlapping keystrokes, the second representation may be used to represent all keystrokes. This may occur, for example, with the use of partially overlapping keystrokes. For example, FIG. 7 illustrates a depiction of keystrokes in which an A keystroke is not fully nested within a shift keystroke. As can be seen in the Figure, this keystroke sequence is represented fully in the second, longer representation mode. As described above for FIG. 6, a macro recorder according to the present disclosure may be configured to switch between representation modes based on representation efficiency and precision. In this way, non-overlapping representations may be depicted in the manner illustrated in FIG. 5, nested keystrokes involving two or more keys can be represented as illustrated in FIG. 6 and overlapping but non-nesting keystrokes involving two or more keys can be represented as illustrated in FIG. 7. Further, the representation mode may switch in real time during a macro recording process such that the longer representation mode is used only upon the receipt of a suitably overlapping keystroke.

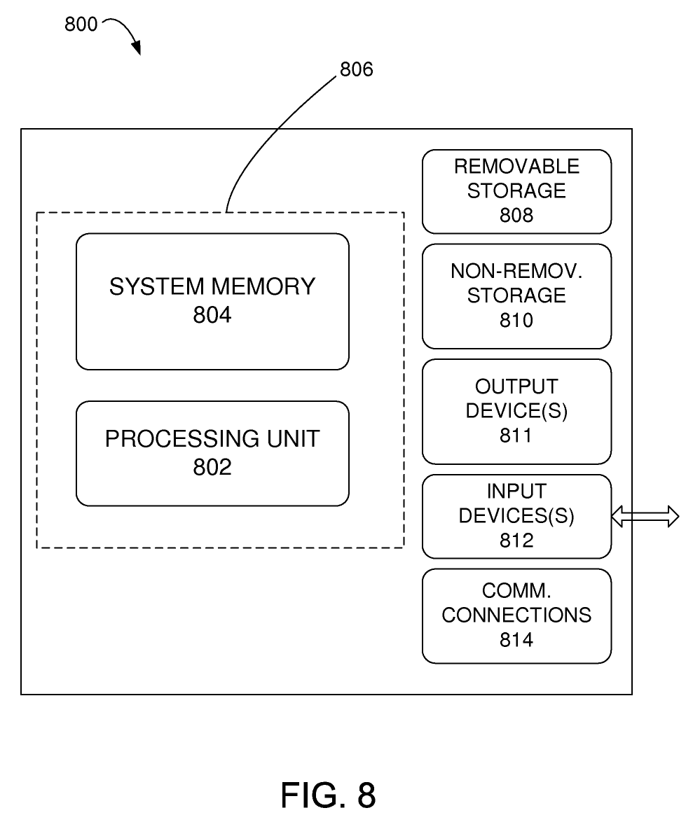

The representations shown in FIGS. 5-7 may be displayed on a graphical user interface displayed on a display of a computing device used in conjunction with mouse 100. Further, in some embodiments, the representations may also/alternatively be displayed on LCD 110 on mouse 100. As shown in FIG. 8, an exemplary computing device 800 comprises a processing unit 802 and memory 804. Depending on the exact configuration and type of computing device, memory 804 may be volatile (such as RAM), non-volatile (such as ROM, flash memory, etc.), or some other memory accessible to processing unit 802. A basic configuration is illustrated in FIG. 8 by dashed line 806.

Additionally, computing device 800 may also have additional features/functionality. For example, device 800 may also include additional storage (removable and/or non-removable) including, but not limited to, magnetic or optical disks or tape. Such additional storage is illustrated in FIG. 8 by removable storage 808 and non-removable storage 810. Computer storage media includes volatile and nonvolatile, removable and non-removable media implemented in any method or technology for storage of information such as computer readable instructions, data structures, program modules or other data. Memory 804, removable storage 808 and non-removable storage 810 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 800. Any such computer storage media may be part of device 800.

Computing device 800 also includes one or more communication connections 814 that allow computing device 800 to communicate with other computers, applications, and/or devices 815. Device 800 may also have input device(s) 812 such as keyboard, mouse, pen, voice input device, touch input device, etc. Output device(s) 811 such as a display, speakers, printer, etc. may also be included. Additionally, some embodiments may include a computer-readable medium having computer-executable instructions for recording and representing a macro on a mouse input device, wherein the instructions perform a method as illustrated with reference to the present disclosure.

While disclosed herein in the context of a computing device with a mouse input device, it will be appreciated that the embodiments may also be used in other suitable devices that use a mouse as an input device.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. In a computing device comprising a display and an input connectable to a mouse operable as a computer input device, a method of recording a macro, comprising:
receiving a macro record command;
receiving one or more input commands to be grouped as the macro;
displaying a representation of the one or more input commands, wherein the representation changes between a first representation mode and a second representation mode based upon the one or more input commands; and
receiving a macro stop record command.

2. The device of claim 1, wherein the representation changes between a first representation mode and a second representation mode when a first input command becomes overlapping with a second input command.

3. The device of claim 2, wherein the representation changes for the second input command when the first input command starts and finishes within the duration of the second input command.

4. The device of claim 1, wherein the method further comprises sending a command to the mouse to illuminate a light on the mouse to represent a macro record mode.

5. The device of claim 1, wherein the method further comprises sending a command to the mouse to display a macro play mode indicator on a mouse display.

6. The device of claim 1, wherein the one or more input commands to be grouped as the macro comprises one or more input commands to adjust mouse movement sensitivity.

7. The device of claim 1, wherein receiving one or more input commands to be grouped as the macro comprises recording a mouse button input while excluding a mouse movement input.

8. A computer-readable medium having computer-executable instructions for recording and representing a macro, the instructions being executable to perform a method comprising:
receiving a macro record command;
receiving one or more input commands to be grouped as the macro;
displaying a representation of the one or more input commands, wherein the representation changes between a first representation mode and a second representation mode when multiple input commands overlap; and
receiving a macro stop record command.

9. The computer-readable medium of claim 8, wherein the representation changes when a first input command becomes overlapping with a second input command.

10. The computer-readable medium of claim 8, further comprising instructions for assigning the macro to a specified input from the mouse, receiving the specified input from the mouse, and performing the one or more input commands grouped as the macro.

11. The computer-readable medium of claim 8, further comprising instructions for sending a command to the mouse to illuminate a light on the mouse to represent a macro record mode.

12. The computer-readable medium of claim 8, further comprising instructions for sending a command to the mouse to display a macro play mode indicator on a mouse display.

13. The computer-readable medium of claim 8, wherein the one or more input commands to be grouped as the macro include one or more input commands to adjust mouse movement sensitivity.

14. The computer-readable medium of claim 8, wherein receiving one or more input commands to be grouped as the macro comprises recording a mouse button input while excluding a mouse movement input.

15. A method for recording and representing a macro via a mouse, the method comprising:
selecting a macro record button on the mouse;
assigning a specified input from the mouse to perform the macro;
selecting one or more input commands to be grouped as the macro; and
selecting a macro stop record command on the mouse.

16. The method of claim 15, further comprising selecting the specified input on the mouse and performing the one or more input commands grouped as the macro.

17. The method of claim 15, further comprising displaying one or more instructions on a mouse display instructing a user how to perform one or more macro recording operations.

18. The method of claim 15, further comprising illuminating a light on the mouse after selecting the macro record button to represent a macro record mode.

19. The method of claim 15, wherein the one or more input commands to be grouped as the macro include one or more input commands to adjust mouse movement sensitivity.

20. The method of claim 15, further comprising displaying a macro play mode indicator on a mouse display.
